(19) United States
(12) Patent Application Publication
(10) Pub. No.: US 2010/0113021 A1
(43) Pub. Date: May 6, 2010

(54) Association of Network Cells with Location Information

(75) Inventors: Jani Petteri Vare, Kaarina (FI); Pekka Talmola, Turku (FI)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 12/262,996

(22) Filed: Oct. 31, 2008

(51) Int. Cl. H04W 36/00

(52) U.S. Cl. 455/436

(57) ABSTRACT

Aspects of the invention provide methods, apparatuses and computer media for providing cell location information in a digital broadcasting system. A mobile terminal uses the cell location information to form a preliminary handover candidate list. A mobile terminal receives reference coordinates for a reference cell, displacement coordinates for a current cell, and displacement coordinates for neighboring cells over a wireless channel. The mobile terminal consequently determines the locations of the current cell and the neighbor cells based on the coordinates. The mobile terminal determines a range distance for the current cell and includes a neighboring cell in a handover candidate list when the neighboring cell is within the range distance, where the range distance is based on an estimated maximum radius of the current cell and optionally on a cell coverage offset. The handover candidate list is further sorted based on distances of the handover candidates from the current cell.

### BACKGROUND

Digital Video Broadcast (DVB) specifications define standards for digital television broadcast systems, including DVB-T, DVB-H, and DVB-T2. DVB-T specifications are directed to a terrestrial digital television (TV) system that is widely deployed in Europe. DVB-H specifications are based on the DVB-T specifications with increased robustness and support for mobility. DVB-T2 specifications update the DVB-T specifications to provide enhanced quality and capacity. Currently, the DVB-based systems broadcast cell location and coverage information by providing the coordinates (latitude and longitude) of the lower left-hand corner a “spherical” rectangle specifying the cell coverage area. Furthermore, the extent (i.e., the size) of the coverage area for longitude and latitude axes is typically included in signaling information. This location information is used to assist cell pre-selection for the handover process in mobile terminals.

With some mobile TV systems, the signaled cell location information is approximated by rectangles, which approximate the physical cell coverage area. However, this approach may be inaccurate because it is often difficult to determine or estimate cell coverage. A wireless terminal that is being served by the TV system may experience suboptimal receiver performance and consequently degraded performance with handovers in the TV system. Moreover, the wireless terminal may perform an associated calculation based on the current location of the wireless terminal and cell coverage, requiring a significant amount of computation power at the mobile terminal. Consequently, there is a real market need to enable a wireless terminal in a TV broadcast system to better determine location information with a reduced computational effort.

### SUMMARY

An aspect provides methods, apparatuses, and computer-readable media for providing cell location information in a digital broadcasting system. A mobile terminal uses the cell location information to form a preliminary handover candidate list.

With another aspect of the invention, a mobile terminal receives reference coordinates for a reference cell, displacement coordinates for a current cell, and displacement coordinates for neighboring cells over a wireless channel. The mobile terminal consequently determines the locations of the current cell and the neighbor cells based on the coordinates. The mobile terminal further determines a range distance for the current cell and includes a neighboring cell in a handover candidate list when the neighboring cell is within the range distance. The displacement coordinates may include latitude and longitude information relative to the reference cell.

With another aspect of the invention, the range distance is based on an estimated maximum radius of the current cell and optionally on cell coverage offset. The estimated maximum radius may be determined by the receiver from transmission parameters that include transmission power, modulation type, and code rate.

With another aspect of the invention, the handover candidate list is sorted based on distances of the handover candidates from the current cell.

With another aspect of the invention, reference coordinates for one or more reference cells are broadcast to the mobile terminal. The mobile terminal selects one of the reference cells for a corresponding neighboring cell based on an indicator that is provided in signaling data.

### BRIEF DESCRIPTION OF THE DRAWINGS

A more complete understanding of the present invention and the advantages thereof may be acquired by referring to the following description in consideration of the accompanying drawings, in which like reference numbers indicate like features and wherein:

FIG. 1 shows an example for determining a location of a cell with respect to a reference cell in accordance with an embodiment of the invention.

FIG. 2 shows an example of a mobile terminal determining a range distance of a current cell in accordance with an embodiment of the invention.

FIG. 3 shows a syntax of a reference cell information descriptor in accordance with an embodiment of the invention.

FIG. 4 shows a syntax of a cell information descriptor in accordance with an embodiment of the invention.

FIG. 5 shows a flow diagram for determining preliminary handover candidates in accordance with an embodiment of the invention.

FIG. 6 shows a block diagram of a mobile terminal in accordance with an embodiment of the invention.

FIG. 7 shows a block diagram of a broadcast station in accordance with an embodiment of the invention.

### DETAILED DESCRIPTION

In the following description of the various embodiments, reference is made to the accompanying drawings which form a part hereof, and in which is shown by way of illustration various embodiments in which the invention may be practiced. It is to be understood that other embodiments may be utilized and structural and functional modifications may be made without departing from the scope of the present invention.

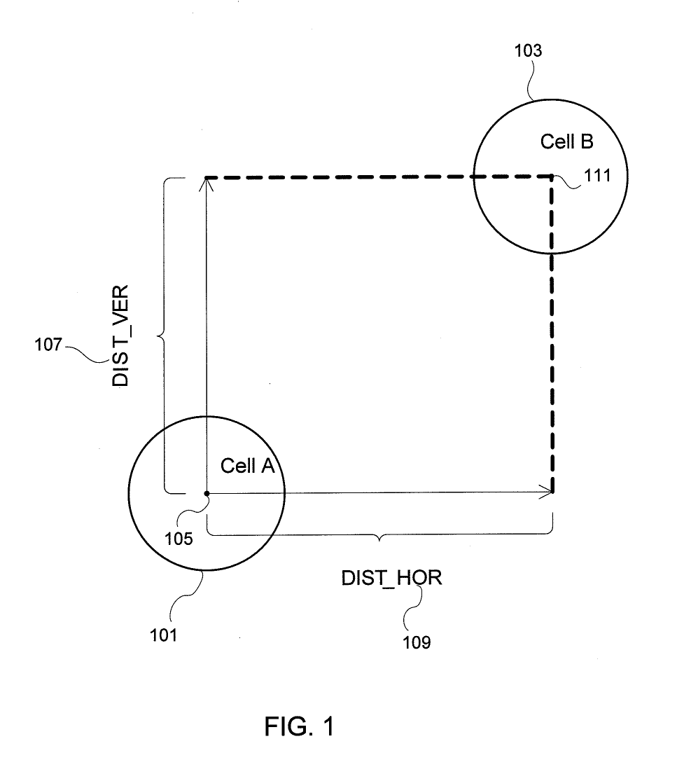

FIG. 1 shows an example for determining a location of cell 103 with respect to a reference cell 101 in accordance with an embodiment of the invention. With some embodiments, reference point 105 is approximately located at the center of reference cell 101.

With some embodiments, a digital broadcast system may provide cell location information to a mobile terminal based only on indication of a reference location and a distance from the reference location rather than the cell location and cell coverage of cells within the digital broadcast system. Furthermore, as will be discussed, in an absence of received coverage information, a mobile terminal (e.g., a receiver, which is typically contained in the mobile terminal being served by a digital broadcast system) may estimate the cell coverage using data available at the receiver to control the cell pre-selection mechanism for handovers. A mobile terminal may include both transmit and receive capabilities. However, with some embodiments, a mobile terminal may have reception-only capabilities (i.e., no transmitter). For example, a mobile terminal may be a mobile television.

However, with other embodiments, reference point 105 may not be associated to a cell, i.e., a reference point may be defined independently of the cells of the digital broadcast network. With other embodiments, a plurality of reference points may be defined, e.g., different cells within a network may be selected as reference cells, where the location of the (other) cells of the network is determined based on the vertical and horizontal distances from the indicated reference point.

Based on reference point 105 and on the DIST_VER 107 (which corresponds to a vertical distance on a plane) and DIST_HOR 109 (which corresponds to a horizontal distance on a plane) (e.g., relative to the approximate center 111 of cell 103), the mobile terminal may determine the location of the current cell that is serving the mobile terminal. For example, DIST_VER 107 may correspond to a latitude displacement while DIST_HOR 109 may correspond to a longitude displacement. The mobile terminal may consequently determine a distance from the current cell to other cells in the digital broadcast system based on reference point 105, DIST_VER 107, and DIST_HOR 109. With some embodiments, DIST_VER 107 and DIST_HOR 109 are sent to a mobile terminal over a signaling channel from a digital broadcast system. In some embodiments the location information of the current cell may be determined based on distance and direction instead of DIST_VER 107 and DIST_HOR 109. The distance may be specified for example as meters (with desired resolution) and the direction may be specified for example as the angle from a chosen reference direction (e.g. the longitude axis).

The location of cell 103 may be determined by adding DIST_VER 107 and DIST_HOR 109 to the latitude and longitude of reference point 105, respectively.

Reference point 105 is typically selected by the broadcast system in order to accommodate the available signaling capacity for the DIST_VER 107 and DIST_HOR 109. With some embodiments, one fixed reference point may result in excessive network capacity consumption of the available signaling capacity. In such cases, a plurality of reference points may be configured, and the appropriate reference point can be indicated for a corresponding cell. One or more reference locations (e.g., reference cells) within a digital broadcast system (network) may be specified and broadcasted in the network. Furthermore, cell locations may be specified and broadcasted as distance from given reference point.

With some embodiments, reference cell 101 is identified by absolute location information, e.g., longitude and latitude corresponding to the center of the cell and/or to the transmitter itself. For the other cells (e.g., cell 103) in the digital broadcast network, the vertical and horizontal distance with a desired accuracy (e.g., 100 meter accuracy calculated from the center of the reference cell) may be provided. This information may be carried on a signaling channel of the broadcast signal.

With some embodiments, a digital broadcast system provides location/coverage signaling information that results in an improved cell pre-selection for handovers with respect to traditional digital broadcast systems. Cell pre-selection by a mobile terminal typically assists with handovers in the digital broadcast system and enables simplified processing at the receiver. The pre-selection of candidate cells for a handover may utilize information on cell locations (the current cell and the neighboring cells) as well as the receiver's estimate on the cell coverage areas as will be discussed.

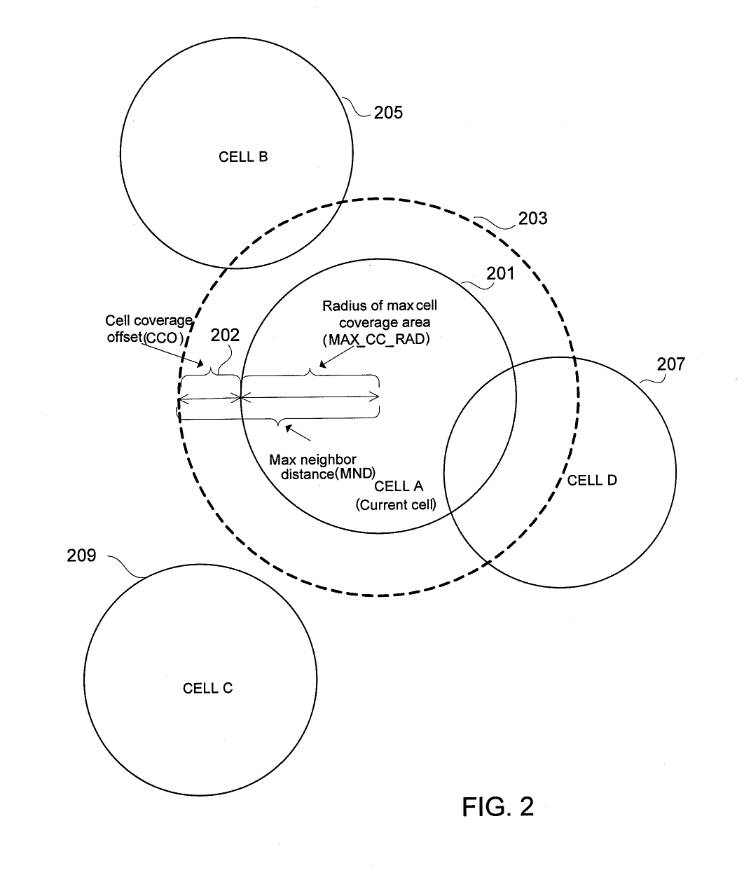

FIG. 2 shows an example of a mobile terminal determining range distance 203 of a current cell in accordance with an embodiment of the invention. With some embodiments, range distance (maximum neighbor distance) 203 is based on maximum cell coverage radius (MAX_CC_RAD) 201 and cell coverage offset (CCO) 202. Cell coverage offset 202 is typically determined by the mobile terminal and is adjusted differently for different networks and may be used only in some digital broadcast systems and/or by some mobile terminals. With some embodiments, cell coverage may be based on a propagation model, e.g., Okumara-Hata, in which the cell coverage depends on the operating frequency, antenna heights of the base station and mobile terminal, and the environment type (small city, large city, suburban, and open area). MAX_CC_RAD 201, which estimates the cell coverage, is determined by the mobile terminal with an embodiment. MAX_CC_RAD 201 may be based on performance parameters, receiver characteristics and antenna gain associated with the mobile terminal. Consequently, MAX_CC_RAD 201 is typically different for different mobile terminals and receivers. The mobile terminal may use transmission parameters (e.g., the transmission power, used modulation, and used code rate) to determine MAX_CC_RAD 201. With some embodiments, a broadcast system provides all or some of these parameters to the mobile terminal. Moreover, in some embodiments default coverage areas for corresponding transmission parameters and receiver/mobile terminal types may be specified rather than the mobile terminal performing the calculation. In addition, signal propagation conditions in different environments may affect the effective cell coverage area. With some embodiments, an indicator about the propagation conditions can be provided to the mobile terminal by the network based on the receiver location. It can also be based on the receiver knowledge of the signal propagation within a specific area. With some embodiments, a specified value can be used as the value of MAX_CC_RAD. This value may be for example a fixed value valid for all cells within a network or within a subset of the cells of a network, or a dedicated value may be specified for each cell of a network.

With some embodiments, if a neighboring cell is within range distance 203 of the current cell, the neighboring cell is included in a cell candidate list (e.g., a preliminary handover candidate list). The candidate list is typically used for the handover. With some embodiments, the list is split into a preliminary handover candidate list and then into a handover candidate list. The preliminary list is collected based on the location. The handover candidate list is then generated as an iterated set of candidates from the first list, based on the actual measured RSSI (signal strength) from the candidates. In the example shown in FIG. 2, cells 205 and 207 are within range distance 203 while cell 209 is not. Consequently, only cells 205 and 207 are included in the preliminary handover candidate list. Moreover, the mobile terminal may further sort (rank order) the handover candidates based on the distance of the candidate to the current cell. In the example shown in FIG. 2, cell 207 is closer to the current cell than cell 205. Thus, cell 207 is ranked higher than cell 205 in the preliminary handover candidate list. For example, some embodiments may use a distance metric (DIST _VER_{neighbor}_{_{—}}_{cell}−DIST_VER_{current}_{_{—}}_{cell})²+(DIST_HOR_{neighbor}_{_{—}}_{cell}−DIST_HOR_{current}_{_{—}}_{cell})² if both the neighbor cell and the current cell are associated with the same reference cell. With some embodiments, cells typically have the same default sizes within the same network. The cell size is auxiliary information, i.e., if a mobile terminal has the capability to estimate the size of the cell (based on the used transmission parameters, environmental factors etc.), it can use the estimated size for the selection of handover candidates. If the mobile terminal is not capable of estimating the size of the cell, then the mobile terminal may use the distance between the center of a neighbor cell and the center of the current cell.

With some embodiments, CCO 202 may or may not be used when determining the preliminary handover candidate list For example, when CCO 202 is not used, only cell 207 (cell D) is included in the list. However, if CCO 202 is used, then both cell 205 (cell B) and cell 207 (cell D) are included in the preliminary handover candidate list. CCO 202 is used to enlarge the assumed cell coverage area of the current cell (typically not for the other cells) and hence for generating more preliminary handover candidates. CCO 202 is typically determined by the mobile terminal. MAX_CC_RAD 201 is determined for all cells (same for all or separate each particular cell) and is used to calculate the overlapping between the current cell and the neighboring cells.

With some embodiments, cell coverage information may be included in signaling information from a digital broadcasting system to a mobile terminal. Cell coverage information may include a range of latitude values and longitude values that a corresponding cell supports. Consequently, the mobile terminal may use the provided cell coverage information rather than determining MAX_CC_RAD 201 as discussed above.

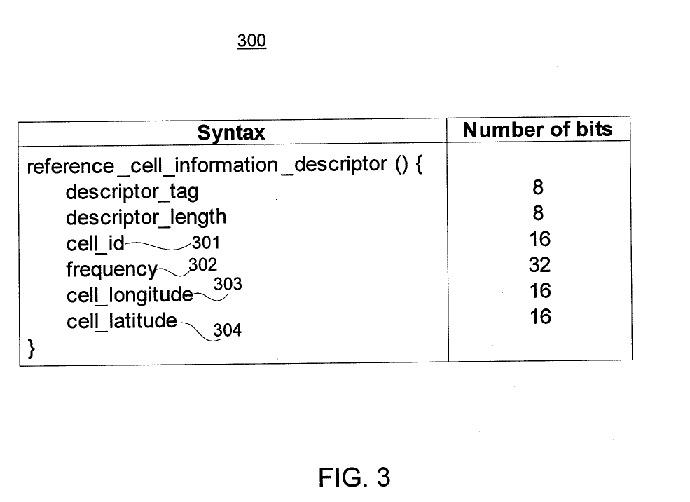

FIG. 3 shows a syntax of reference cell information descriptor 300 (corresponding to reference cell 101 as shown in FIG. 1) in accordance with an embodiment of the invention. The reference information is typically network-specific because of signaling limitations. All cells in the network typically transmit the same network information. A digital broadcast system transmits signaling information with reference cell information descriptor 300 in order to provide the location of reference point 105. With some embodiments, reference point 105 is identified by cell_longitude 303 and cell_latitude 304. With one embodiment, descriptor 300 includes:
cell_id (301)—16-bit field which uniquely identifies a cell within network.
frequency (302)—32-bit field that identifies the frequency that is used in the indicated cell.
cell_longitude (303)—16-bit field that is encoded as a two's complement number. It specifies the longitude of the center of the cell coverage area of the cell indicated. It may be calculated by multiplying the value of the longitude field by an associated conversion factor (180°/2¹⁵). Western longitudes are considered negative and eastern longitudes positive.
cell_latitude (304)—16-bit field that is encoded as encoded as a two's complement number. It specifies the latitude of the center of the cell coverage area of the cell indicated. It may be calculated by multiplying the value of the latitude field by an associated conversion factor (90°/2¹⁵). Southern latitudes are considered negative and northern latitudes positive.

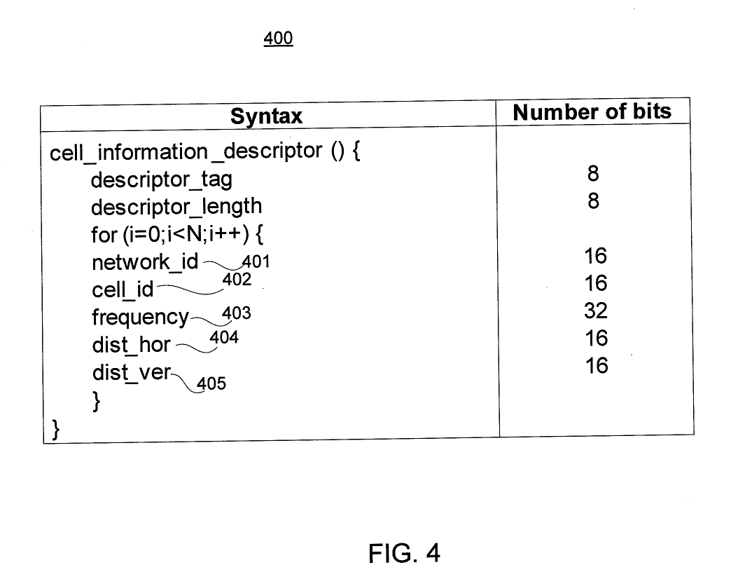

FIG. 4 shows a syntax of cell information descriptor 400 broadcast by the broadcast station in the current cell in accordance with an embodiment of the invention. Descriptor 400 includes dist_hor parameter 404 and dist_ver parameter 405 corresponding to DIST_HOR 109 and DIST_VER 107, respectively, as shown in FIG. 1.

With the example embodiment shown in FIG. 4, cell_information_descriptor 400 includes:
network_id (401)—16-bit field which uniquely identifies the network.
cell_id (402)—16-bit field which uniquely identifies a cell within network.
frequency (403)—32-bit field identifies the frequency that is used in the indicated cell.
dist_hor (404)—16-bit field that specifies the horizontal distance to the associated cell from the center of the cell signaled within the reference_cell_information_descriptor. Information for cell_information_descriptor 400 is typically provided by the network operator and is typically network specific, e.g., for the DVB network that is identified with network_id (16 bits) and may consist of several cells (one cell is identified with cell id (16 bits)). The value within this field is multiplied by 20 meters. In one example, the minimum value (0x01) is equal to 20 m×1=20 meters and the maximum value (0xff) is equal to 65536 m×20=1310.72 kilometers.
dist_ver (405)—16-bit field that specifies the vertical distance to the associated cell from the center of the cell signaled within the reference_cell_information_descriptor. The value within this field is multiplied by 20 meters. In one example, the minimum value (0x01) is equal to 20 m×1=20 meters and the maximum value (0xff) is equal to 65536 m×20=1310.72 kilometers.

Some embodiments support more than one reference cell. Consequently, cell information descriptor 400 may be extended to cover also a parameter referring to selected reference cell. For example a parameter “ref_cell_id” (16 bits) may be added to carry a value of the “cell_id” field of the selected reference cell information descriptor 300.

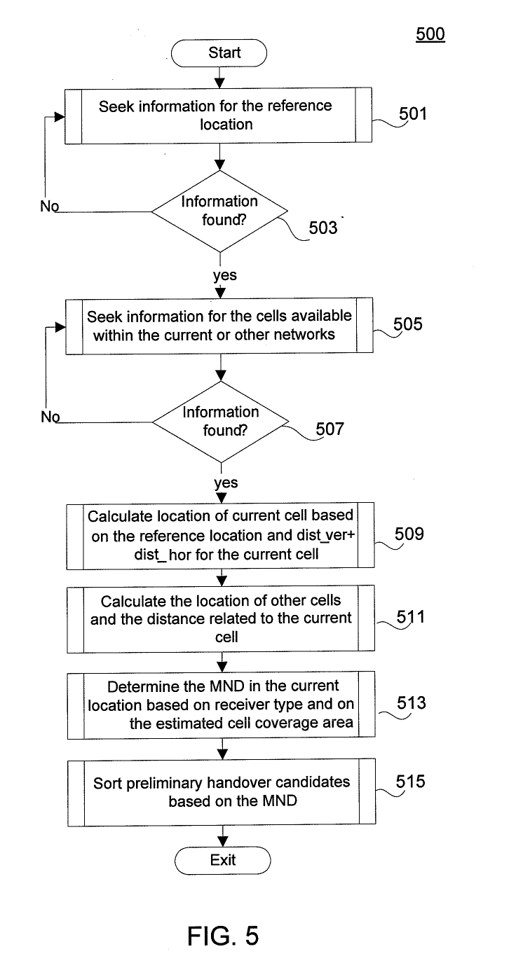

FIG. 5 shows flow diagram 500 for determining preliminary handover candidates in accordance with an embodiment of the invention.

In step 501, the mobile terminal receives reference_cell_information_descriptor 300, or some other data structure which carries the same information, to obtain cell_id, frequency, cell_longitude and cell_latitude of the reference cell in the broadcast system. If this information has not been acquired, the mobile terminal attempts to acquire the information in step 503.

In step 505, the mobile terminal receives cell_information_descriptor 400 to obtain information about other available cells in the digital broadcast system. This information may be available in one or more cell_information_descriptors. Each descriptor 400 contains frequency, cell_id, dist_ver and dist_hor for each corresponding cell. Step 505 is repeated until information for all cells is acquired as determined by step 507.

In step 509, the mobile terminal determines the location of the current cell based on the information provided for the reference location and based on the dist_ver and dist_hor provided for the current cell. The location of the current cell can be determined by adding cell_longitude 303 to dist_hor 404 and cell_latitude 304 to dist_ver 405.

In step 511, the location for each cell discovered in step 505 is determined based on the reference location information and on the dist_hor and dist_ver provided for each cell. Also, the distance from the current cell to the other cells present within the network may be determined. For example, as previously discussed, a distance metric (dist_Ver_{neighbor}_{_{—}}_{cell}−dist_ver_{current}_{_{—}}_{cell})²+(dist_hor_{neighbor}_{_{—}}_{cell}−dist_hor_{current}_{_{—}}_{cell})² may be used.

In step 513, the mobile terminal determines the range distance (maximum neighbor distance (MND)) based on the receiver physical parameters of the received signal and on other factors affecting the cell coverage area. With some embodiments, the MND is derived directly from the distance from the center of the current cell to the distance to the neighboring cell. The mobile terminal may further determine the cell coverage offset (CCO) as previously discussed.

In step 515, the mobile terminal determines and sorts the preliminary handover candidates which are within the range distance.

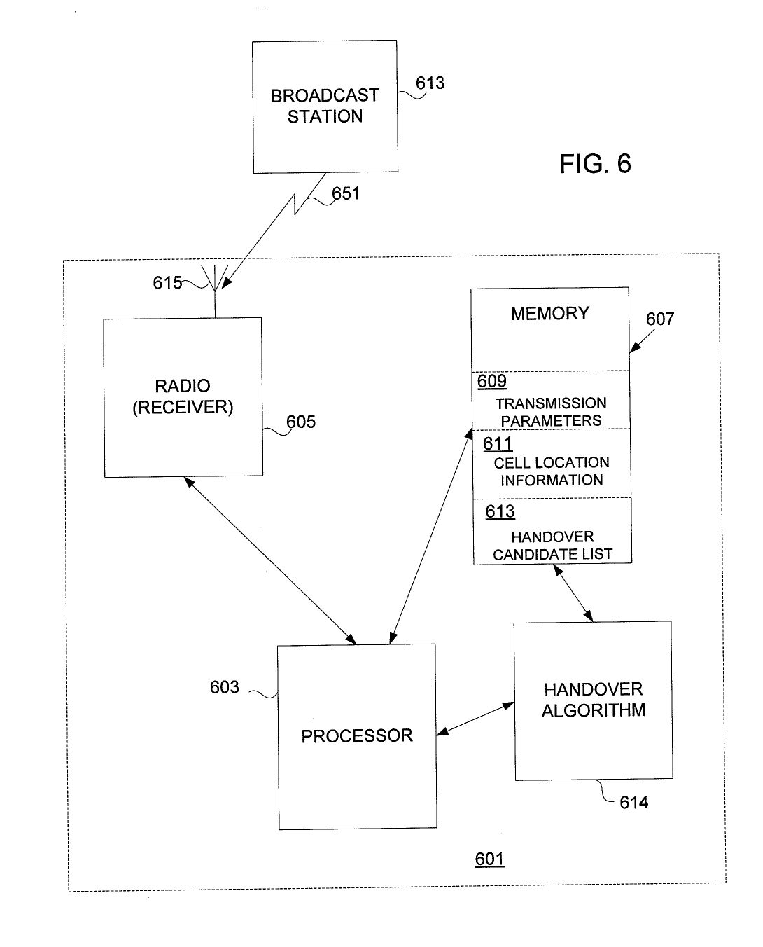

FIG. 6 shows a block diagram of mobile terminal 601 that receives a digital broadcasting signal 651 through antenna 615 from broadcast station 613 in accordance with an embodiment of the invention. Processor 603 receives cell location information (e.g., reference_cell_information descriptor 300 and cell_information_descriptor 400) from receiver (radio) 605 and stores cell location information 611 and transmission parameters 609 in memory 607. Processor 603 consequently determines and stores handover candidate list 613 in memory 607 and uses handover algorithm 614 to determine what cell should be selected when a handover is needed based, for example, on movement (direction) in location.

Processor 603 may execute computer executable instructions from a computer-readable medium, e.g., memory 607. Computer storage media may include volatile and nonvolatile, removable and non-removable media implemented in any method or technology for storage of information such as computer readable instructions, data structures, program modules or other data. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by processor 701.

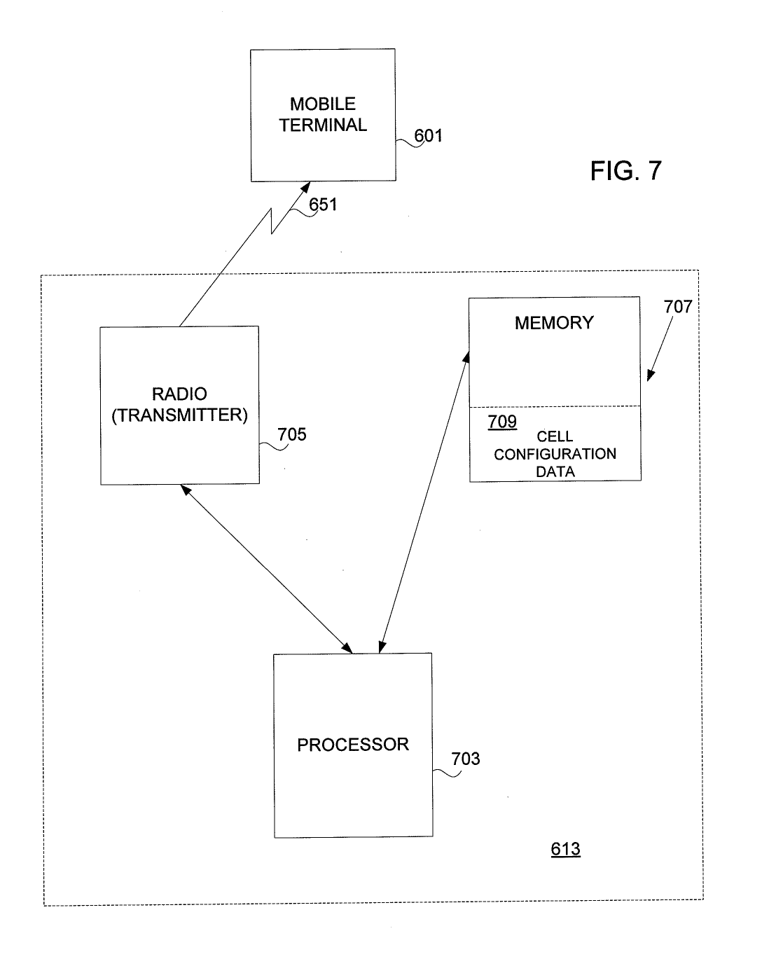

FIG. 7 shows block diagram 700 of broadcast station 613 in accordance with an embodiment of the invention. Memory 707 contains cell configuration data 709 including cell location information. Processor 703 sends the cell location information to mobile terminal 601 through transmitter (radio 705) over broadcasting signal 651 in reference_cell_information descriptor 300 and cell_information_descriptor 400 as previously discussed. Processor 703 may execute computer executable instructions from a computer-readable medium, e.g., memory 707 as described above in connection with FIG. 6.

The terms “processor” and “memory” as used herein, whether collectively or singly, should be interpreted to cover processing circuitry of various kinds such as field programmable gate arrays, application-specific integrated circuits, and combinations thereof.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

We claim:

1. An apparatus comprising:
a memory; and
a processor configured to retrieve instructions from the memory and to perform:
receiving reference coordinates for a reference cell, current displacement coordinates for a current cell, and first neighbor displacement coordinates for a first neighbor cell of a broadcast system over a wireless channel;
determining a current location of the current cell from the reference coordinates and the current displacement coordinates and determining a first location of the first neighbor cell from the reference coordinates and the first neighbor displacement coordinates;
determining a range distance of the current cell; and
when the first neighbor cell is within the range distance, including the first neighbor cell in a cell candidate list.

2. The apparatus of claim 1, wherein the processor is further configured to:
determine the range distance based on an estimated maximum radius of the current cell.

3. The apparatus of claim 2, further comprising:
an antenna configured to obtain a signal from a broadcast station that is located in the current cell;
a receiver configured to process the signal; and
wherein the processor is further configured to:
determine the estimated maximum radius based on performance characteristics of the receiver and the antenna.

4. The apparatus of claim 3, wherein the processor is further configured to:
determine the estimated maximum radius further based on at least one transmission parameter.

5. The apparatus of claim 4, wherein the at least one transmission parameter is selected from the group consisting of a transmission power, a modulation type, and a code rate.

6. The apparatus of claim 1, wherein the current displacement coordinates include a current relative latitude and a current relative longitude and the first neighbor displacement coordinates include a first neighbor relative latitude and a first neighbor relative longitude.

7. The apparatus of claim 2, wherein the processor is further configured to:
determine the range distance further based on a cell coverage offset.

8. The apparatus of claim 1, wherein:
the reference coordinates include first reference coordinates for a first reference cell and second reference coordinates for a second reference cell; and
wherein the processor is further configured to:
select, based on received information, the reference coordinates from one of the first reference coordinates and the second reference coordinates.

9. The apparatus of claim 2, further comprising:
a receiver configured to process a signal; and
wherein the processor is further configured to:
determine the estimated maximum radius based on a receiver type and on an estimated cell coverage area of the current cell.

10. The apparatus of claim 1, wherein the processor is further configured to:
receive second neighbor displacement coordinates for a second neighbor cell;
determine a second location of the second neighbor cell from the reference coordinates and the second neighbor displacement coordinates; and
when the second cell is within the range distance, include the second neighbor cell in the cell candidate list.

11. The apparatus of claim 1, wherein the processor is further configured to:
sort the cell candidate list based on distances of candidate cells from the current cell.

12. A computer-readable medium having computer-executable instructions that when executed perform:
receiving reference coordinates for a reference cell, current displacement coordinates for a current cell, and first neighbor displacement coordinates for a first neighbor cell of a broadcast system;
determining a current location of the current cell from the reference coordinates and the current displacement coordinates and a first location of the first neighbor cell from the reference coordinates and the first neighbor displacement coordinates;
determining a range distance of the current cell; and
when the first neighbor cell is within the range distance, including the first neighbor cell in a cell candidate list.

13. The computer-readable medium of claim 12, wherein the instructions further perform:
determining the range distance based on an estimated maximum radius of the current cell.

14. The computer-readable medium of claim 13, wherein the instructions further perform:
determining the range distance further based on a cell coverage offset.

15. The computer-readable medium of claim 12, wherein the instructions further perform:
selecting the reference coordinates from one of the first reference coordinates and the second reference coordinates, wherein the first reference coordinates are associated with a first reference cell and the second reference coordinates are associated with a second reference cell.

16. The computer-readable medium of claim 12, wherein the instructions further perform:
sorting the cell candidate list based on distances of candidate cells from the current cell.

17. A method comprising:
receiving reference coordinates for a reference cell, current displacement coordinates for a current cell, and first neighbor displacement coordinates for a first neighbor cell of a broadcast system over a wireless channel;
determining a current location of the current cell from the reference coordinates and the current displacement coordinates and a first location of the first neighbor cell from the reference coordinates and the first neighbor displacement coordinates;
determining a range distance of the current cell; and
when the first neighbor cell is within the range distance, including the first neighbor cell in a cell candidate list.

18. The method of claim 17, further comprising:
determining the range distance based on an estimated maximum radius of the current cell.

19. The method of claim 18, further comprising:
receiving a signal from a broadcast station through a receiver and an antenna; and
determining the estimated maximum radius based on performance characteristics of the receiver and the antenna.

20. The method of claim 19, further comprising:
determining the estimated maximum radius further based on at least one transmission parameter.

21. The method of claim 20, wherein the at least one transmission parameter is selected from the group consisting of a transmission power, a modulation type, and a code rate.

22. The method of claim 17, wherein the current displacement coordinates include a current relative latitude and a current relative longitude and the first neighbor displacement coordinates include a first neighbor relative latitude and a first neighbor relative longitude.

23. The method of claim 18, further comprising:
determining the range distance further based on a cell coverage offset.

24. The method of claim 17, wherein the reference coordinates include first reference coordinates for a first reference cell and second reference coordinates for a second reference cell, the method further comprising:
selecting the reference coordinates from one of the first reference coordinates and the second reference coordinates.

25. The method of claim 18, further comprising:
determining the estimated maximum radius based on a receiver type and on an estimated cell coverage area of the current cell.

26. The method of claim 17, further comprising:
receiving second neighbor displacement coordinates for a second neighbor cell;
determining a second location of the second neighbor cell from the reference coordinates and the second neighbor displacement coordinates; and
when the second cell is within the range distance, including the second neighbor cell in the cell candidate list;

27. The method of claim 17, further comprising:
sorting the cell candidate list based on distances of candidate cells from the current cell.

28. An apparatus comprising:
a memory; and
a processor configured to retrieve instructions from the memory and to perform:
sending first reference coordinates for a first reference cell of a broadcast system over a wireless channel, wherein the first reference coordinates include an absolute latitude value and an absolute longitude value of an approximate center of the first reference cell; and
sending displacement coordinates of a first cell of the broadcast system over the wireless channel, wherein the displacement coordinates include a relative latitude value and a relative longitude value with respect to the approximate center of the first reference cell.

29. The apparatus of claim 28, wherein the processor is further configured to:
send second reference coordinates for a second reference cell, wherein the second reference coordinates identify an approximate center of the second reference cell; and
send an indicator that indicates a selected reference cell, wherein the selected reference cell is one of the first reference cell and the second reference cell.

30. A computer-readable medium having computer-executable instructions that when executed perform:
sending first reference coordinates for a first reference cell of a broadcast system over a wireless channel, wherein the first reference coordinates include an absolute latitude value and an absolute longitude value of an approximate center of the first reference cell; and
sending displacement coordinates of a first cell of the broadcast system over the wireless channel, wherein the displacement coordinates include a relative latitude value and a relative longitude value with respect to the approximate center of the first reference cell.

31. The computer-readable medium of claim 30, wherein the instructions further perform:
sending second reference coordinates for a second reference cell, wherein the second reference coordinates identify an approximate center of the second reference cell; and
indicating a selected reference cell from the first reference cell and the second reference cell.

32. A method comprising:
sending first reference coordinates for a first reference cell of a broadcast system over a wireless channel, wherein the first reference coordinates include an absolute latitude value and an absolute longitude value of an approximate center of the first reference cell; and
sending displacement coordinates of a first cell of the broadcast system over the wireless channel, wherein the displacement coordinates include a relative latitude value and a relative longitude value with respect to the approximate center of the first reference cell.

33. The method of claim 32 further comprising:
sending second reference coordinates for a second reference cell, wherein the second reference coordinates identify an approximate center of the second reference cell; and
indicating a selected reference cell from a first reference cell and a second reference cell.

34. The apparatus of claim 1, wherein the cell candidate list comprises a handover candidate list.

35. The computer-readable medium of claim 12, wherein the cell candidate list comprises a handover candidate list.

36. The method of claim 17, wherein the cell candidate list comprises a handover candidate list.
